(19) United States
(12) Patent Application Publication
(10) Pub. No.: US 2007/0080625 A1
(43) Pub. Date: Apr. 12, 2007

(54) Display device

(76) Inventors: Shang-Hyeun Park, Boryeong-si (KR); Jeong-Hee Lee, Seongnam-si (KR); Yong-Wan Jin, Seoul (KR); In-Taek Han, Seoul (KR); Jeong-Na Heo, Yongin-si (KR); Tae-Won Jeong, Seoul (KR)

Correspondence Address: Robert E. Bushnell, Suite 300, 1522 K Street, N.W., Washington, DC, 20005-1202, US

(21) Appl. No.: 11/449,738

(22) Filed: Jun. 9, 2006

(30) Foreign Application Priority Data
Oct. 11, 2005 (KR) 10-2005-0095498

(51) Int. Cl. H01J 63/04; H01J 1/62

(52) U.S. Cl. 313/496

(57) ABSTRACT

A display device includes: a first substrate and a second substrate, a plurality of first electrodes, a light emitting layer, and a plurality of second electrodes. The first and second substrates are spaced apart to face each other, and the plurality of first electrodes are formed on an inner surface of the first substrate. The light emitting layer is arranged on the plurality of first electrodes and includes phosphor bodies and light emitting sources mixed therein. The plurality of second electrodes are arranged on an inner surface of the second substrate.

### CLAIM OF PRIORITY

This application makes reference to, incorporates the same herein, and claims all benefits accruing under 35 U.S.C. §119 from an application for DISPLAY DEVICE earlier filed in the Korean Intellectual Property Office on the 11^{th} of Oct. 2005 and there duly assigned Serial No. 10-2005-0095498.

### BACKGROUND OF THE INVENTION

1. Field of the Invention

The present invention relates to a display device, and more particularly, to a display device having a new simple structure, capable of being easily manufactured and reducing manufacturing costs.

2. Description of the Related Art

Display devices, which are important parts of the prior art information delivery medium, are mainly used for monitors of personal computers and television receivers. The display devices can be roughly divided into Cathode Ray Tubes (CRTs) using high speed thermal electron emission and flat panel displays that are rapidly being developing recently. The flat panel displays include Liquid Crystal Displays (LCDs), Plasma Display Panels (PDPs), and Field Emission Displays (FEDs).

The FEDs are display devices emitting light by emitting electrons from an emitter formed on a cathode and by allowing the electrons to collide with a phosphor layer coated on an anode.

An FED generally includes a lower substrate and an upper substrate spaced apart from each other. The lower substrate and the upper substrate are separated a predetermined distance apart by spacers disposed therebetween. A cathode is formed on the lower substrate. An insulation layer and a gate electrode for electron extraction are sequentially formed on the cathode. An emitter aperture exposing the cathode is formed in the insulation layer, and an emitter, which is an electron emitting source, is formed in the inside of the emitter aperture. An anode is formed on the lower surface of the upper substrate. A phosphor layer excited by electrons emitted from the emitter and emitting visible light of a predetermined color is coated on the anode.

When a predetermined voltage is supplied between the cathode and the gate electrode in the FED, electrons are emitted from the emitter formed on the cathode on the inside of the emitter aperture. The emitted electrons go toward the anode and collide with the phosphor layer formed on the anode. Accordingly, the phosphor layer is excited to emit visible light of a predetermined color.

However, an FED having the above structure includes the gate electrode formed on the insulation layer and the emitter provided on the inside of the emitter aperture formed in the insulation layer, which is a more or less complicated structure. Also, the FED requires a separate focusing structure capable of controlling the traces of electrons so that the electrons emitted from the emitter can reach a desired location on the anode.

### SUMMARY OF THE INVENTION

The present invention provides a display device having a new structure, capable of achieving a simple structure and reducing manufacturing costs.

According to an aspect of the present invention, a display device is provided including: a first substrate and a second substrate spaced apart to face each other; a plurality of first electrodes arranged on an inner surface of the first substrate; a light emitting layer, including a mix of phosphor bodies and light emitting sources, arranged on the plurality of first electrodes; and a plurality of second electrodes arranged on an inner surface of the second substrate.

The light emitting sources preferably include electron emitting sources. The electron emitting sources preferably include either Carbon NanoTubes (CNTs) or nanowires.

A plurality of spacers are preferably arranged between the first substrate and the second substrate to effect a constant spacing between the first substrate and the second substrate.

The first substrate and second substrates each preferably includes a transparent substrate. The first and second substrates each preferably includes a glass substrate.

The plurality of first and second electrodes preferably include transparent electrodes. The plurality of first and second electrodes include Indium Tin Oxide (ITO). The plurality of first electrodes preferably include stripes arranged in parallel to each other and w the plurality of second electrodes are preferably arranged to be perpendicular to the plurality of first electrodes.

An AC voltage is preferably supplied between the plurality of first electrodes and the plurality of second electrodes.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial sectional view of a Field Emission Display (FED);

FIG. 2 is a separated perspective view of a display device according to an embodiment of the present invention;

FIG. 3 is a partial sectional view of a display device according to an embodiment of the present invention;

FIG. 4 is an enlarged view of an A portion of FIG. 3; and

FIG. 5 is a graph of current versus voltage characteristics according to the density change of a carbon nanotube in a display device according to an embodiment of the present invention.

### DETAILED DESCRIPTION OF THE INVENTION

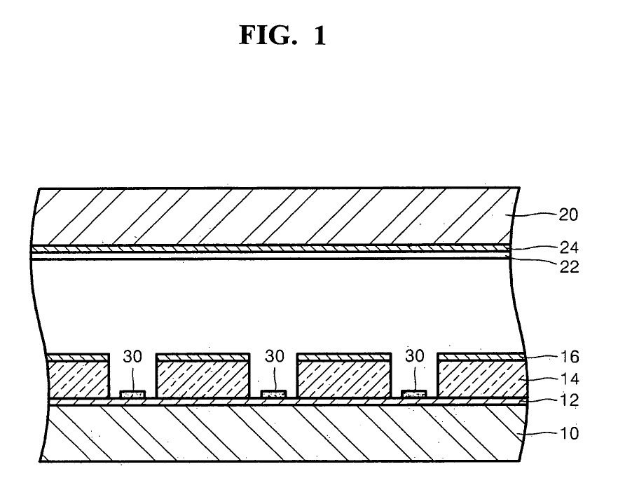

FIG. 1 is a partial sectional view of a Field Emission Display (FED). Referring to FIG. 1, the FED includes a lower substrate 10 and an upper substrate 20 spaced apart from each other. The lower substrate 10 and the upper substrate 20 are separated a predetermined distance apart by spacers (not shown) disposed therebetween. A cathode 12 is formed on the lower substrate 10. An insulation layer 14 and a gate electrode 16 for electron extraction are sequentially formed on the cathode 12. An emitter aperture exposing the cathode 12 is formed in the insulation layer 14, and an emitter 30, which is an electron emitting source, is formed in the inside of the emitter aperture. An anode 22 is formed on the lower surface of the upper substrate 20. A phosphor layer 24 excited by electrons emitted from the emitter 30 and emitting visible light of a predetermined color is coated on the anode 22.

When a predetermined voltage is supplied between the cathode 12 and the gate electrode 16 in the FED, electrons are emitted from the emitter 30 formed on the cathode 12 on the inside of the emitter aperture. The emitted electrons go toward the anode 22 and collide with the phosphor layer 24 formed on the anode 22. Accordingly, the phosphor layer 24 is excited to emit visible light of a predetermined color.

However, an FED having the above structure includes the gate electrode 16 formed on the insulation layer 14 and the emitter 30 provided on the inside of the emitter aperture formed in the insulation layer 14, which is a more or less complicated structure. Also, the FED requires a separate focusing structure capable of controlling the traces of electrons so that the electrons emitted from the emitter 30 can reach a desired location on the anode 22.

The present invention is described more fully below with reference to the accompanying drawings, in which exemplary embodiments of the present invention are shown. Like reference numerals in the drawings denote like elements, and thus their description has been omitted.

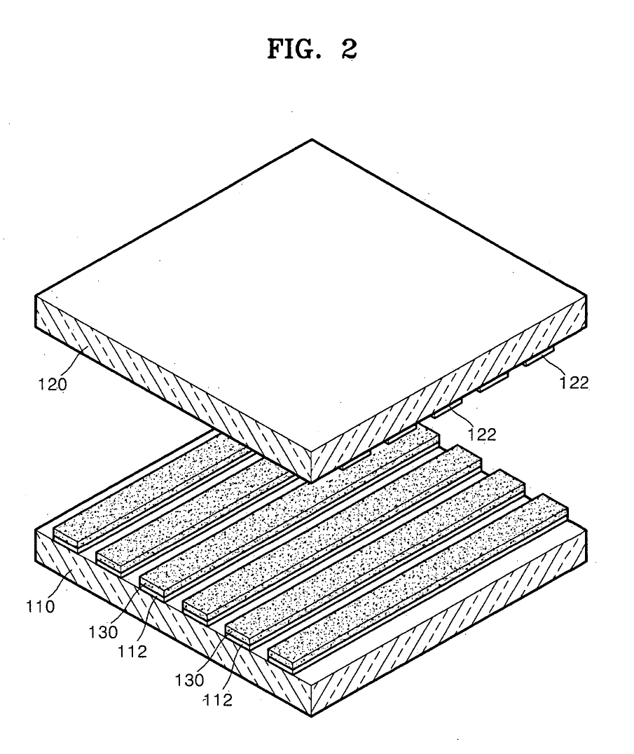

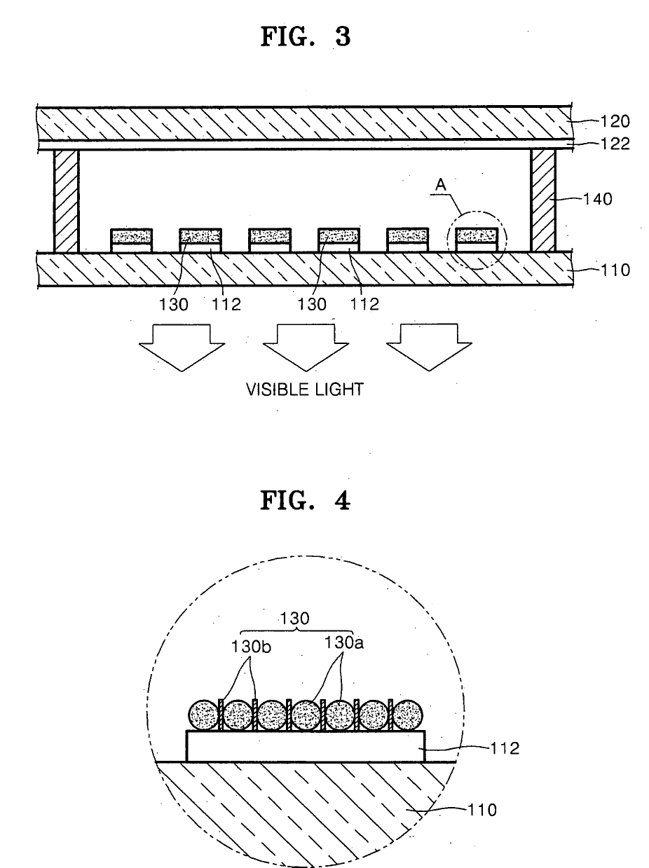

FIG. 2 is a schematic separated perspective view of a display device according to an embodiment of the present invention, FIG. 3 is a partial sectional view of the display device of FIG. 2, and FIG. 4 is an enlarged view of an A portion of FIG. 3.

Referring to FIGS. 2 through 4, the first substrate 110, which is a lower substrate, and the second substrate 120, which is an upper substrate, are spaced apart from each other. The first and second substrates 110 and 120 can be transparent substrates such as glass substrates. A plurality of spacers 140 maintaining a constant spacing between the first substrate 1 10 and the second substrate 120 is provided between the first substrate 110 and the second substrate 120. A space between the first and second substrates 110 and 120 is sealed, so that the inside of the space maintains a vacuum state.

A plurality of first electrodes 112 are formed on the inner surface of the first substrate 110. The first electrodes 112 can be formed as stripes which are parallel to each other. The first electrodes 112 can be transparent electrodes consisting of transparent conductive materials, e.g., Indium Tin Oxide (ITO).

A light emitting layer 130 where phosphor bodies 130a and light emitting sources 130b are mixed is formed on each of the first electrodes 112. The light emitting sources 130b can be electron emitting sources. The electron emitting sources can be formed of a material having excellent electron emitting characteristics such as Carbon NanoTubes (CNTs) or nanowires. The phosphor bodies 130a are excited by electrons emitted from the electron emitting sources to emit visible light of a predetermined color. Accordingly, the light emitting layers including the phosphor bodies of predetermined colors (e.g., red (R), green (G), and blue (B)) are alternately formed on the first electrodes 110. The light emitting layer 130 can be formed by mixing the phosphor bodies 130a and the light emitting sources 130b in a solvent and coating the solvent on each of the first electrodes 110 using screen printing, a doctor blade method, spin coating, or spraying.

A plurality of second electrodes 122 are formed on the inner surface of the second substrate 120. The second electrodes 122 can be formed to be perpendicular to the first electrodes 112 formed on the first substrate 110. Like the first electrodes 112, the second electrodes 122 can be transparent electrodes consisting of transparent conductive materials, e.g., ITO.

In the display device having the above structure, when a voltage is supplied between the first electrodes 112 and the second electrodes 122, electrons are emitted from the light emitting sources 130b (i.e., electron emitting sources) contained in the light emitting layer 130 formed on the first electrodes 112. The emitted electrons excite the phosphor bodies 130a contained in the light emitting layer 130 to allow visible light of a predetermined color to be emitted to the outside through the first substrate 110, which is the lower substrate, so that an image is formed. A DC voltage can be supplied between the first electrodes 112 and the second electrodes 122, but desirably, an AC voltage can also be supplied therebetween.

As described above, in the display device according to an embodiment of the present invention, the light emitting layer 130 where the phosphor bodies 130a and the light emitting sources 130b are mixed is formed on each of the first electrodes 112. The light emitting layer 130 emits light using an applied voltage, thereby forming an image. Therefore, the display device according to an embodiment of the present invention has a very simple structure compared to other kinds of display devices.

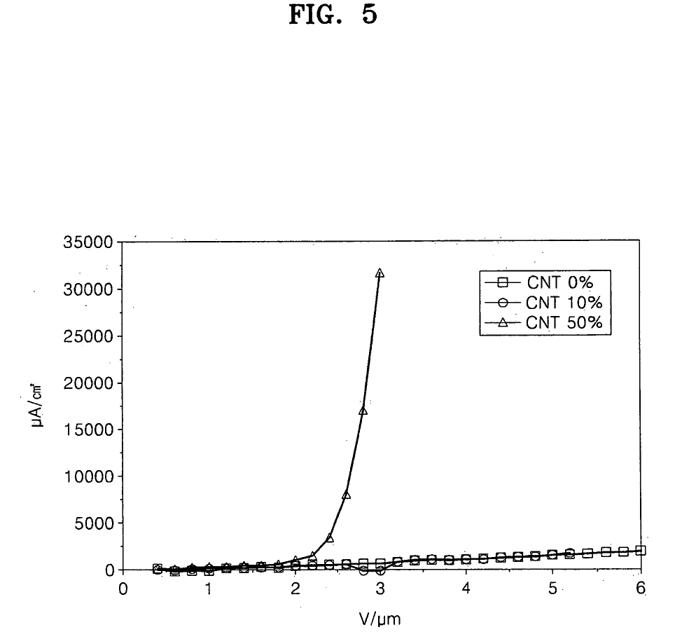

FIG. 5 is a graph of current versus voltage characteristics according to the density change of CNTs serving as a light emitting source in a display device according to an embodiment of the present invention. An interval between the first substrate and the second substrate can be 500 μm. Referring to FIG. 5, in the display device according to an embodiment of the present invention, an almost unmeasurable current occurs when the densities of the CNTs within the light emitting layer are 0% and 10%, respectively. On the contrary, a current amount by which a desired image can be obtained has been measured when the density of the CNTs is 50%.

As described above, the display device according to an embodiment of the present invention can have a very simple structure compared to other display devices by providing the light emitting layer (where the phosphor bodies and the light emitting sources are mixed) on each of the electrodes to allow light to be emitted therefrom. Therefore, the manufacturing of the display device is easy and thus the manufacturing costs thereof are reduced. Also, since visible light emitted from the light emitting layer is directly emitted through the lower substrate, light emitting efficiency is increased, and a separate focusing structure, which has previously been required for FEDs, is not required.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A display device, comprising:
a first substrate and a second substrate spaced apart to face each other;
a plurality of first electrodes arranged on an inner surface of the first substrate;
a light emitting layer, including a mix of phosphor bodies and light emitting sources, arranged on the plurality of first electrodes; and
a plurality of second electrodes arranged on an inner surface of the second substrate.

2. The display device of claim 1, wherein the light emitting sources comprise electron emitting sources.

3. The display device of claim 2, wherein the electron emitting sources comprise either Carbon Nano Tubes (CNTs) or nanowires.

4. The display device of claim 1, wherein a plurality of spacers are arranged between the first substrate and the second substrate to effect a constant spacing between the first substrate and the second substrate.

5. The display device of claim 1, wherein the first substrate and second substrates each comprises a transparent substrate.

6. The display device of claim 1, wherein the first and second substrates each comprises a glass substrate.

7. The display device of claim 1, wherein the plurality of first and second electrodes comprise transparent electrodes.

8. The display device of claim 7, wherein the plurality of first and second electrodes comprise Indium Tin Oxide (ITO).

9. The display device of claim 7, wherein the plurality of first electrodes comprise stripes arranged in parallel to each other and wherein the plurality of second electrodes are arranged to be perpendicular to the plurality of first electrodes.

10. The display device of claim 1, wherein an AC voltage is supplied between the plurality of first electrodes and the plurality of second electrodes.
